(19) United States
(12) Patent Application Publication
(10) Pub. No.: US 2020/0148551 A1
(43) Pub. Date: May 14, 2020

(54) Water Treatment Tank Method And Apparatus

(71) Applicant: Aqua Research LLC, Albuquerque, NM (US)

(72) Inventors: Rodney E Herrington, Albuquerque, NM (US); Kevin Roderick, Albuquerque, NM (US)

(21) Appl. No.: 16/610,072

(22) PCT Filed: May 4, 2018
(86) PCT No.: PCT/US18/31126

§ 371 Date: Oct. 31, 2019

Related U.S. Application Data
(60) Provisional application No. 62/502,759, filed on May 7, 2017.

(51) Int. Cl. C02F 1/00; B01D 35/027

(52) U.S. Cl. CPC C02F 1/006; B01D 35/027; C02F 2301/066; C02F 2303/04; C02F 1/001

(57) ABSTRACT

Embodiments of the present invention provide a water purification and storage system, comprising (a) a tank configured to accept and hold water, and (b) a filter mounted with the tank in a configuration such that the filter is contacted by water in the tank when the tank is in its normal storage orientation and the water in the tank is 25% or more of the tank's holding capacity.

### TECHNICAL FIELD

The subject invention relates to the field of water storage and disinfection.

### BACKGROUND ART

LifeSaver Company (United Kingdom) has developed what is known as the “LifeSaver Jerry Can”. This is a 20 liter container made from high density polyethylene (HDPE) and incorporates an ultra-filter made by Inge Corporation and an air pump. The filter enters the tank at the top and hangs down in the tank. Cross holes go through the tank to connect both sides of the tank and limit the tank expansion when air pressure is applied inside the tank.

### DISCLOSURE OF INVENTION

The present invention relates to a water storage tank. The water storage tank incorporates a filter device. The filtration device can be a micro filter, ultra filter, or other commonly used filter. In some embodiments the tank incorporates a storage location for a clean water container, a storage for a disinfection device, or both.

Embodiments of the present invention provide a water purification and storage system, comprising (a) a tank configured to accept and hold water, and (b) a filter mounted with the tank in a configuration such that the filter is contacted by water in the tank when the tank is in its normal storage orientation and the water in the tank is 25% or more of the tank's holding capacity.

In some embodiments, the system further comprises an air pump mounted with the tank and configured to allow a user to pressurize the contents of the tank such that water is forced under pressure through the filter. In some embodiments, the system further comprises a disinfection system mounted with the tank, configured to supply a chemical disinfectant in quantities suitable for treating a volume of water equal to the tank's holding capacity.

In some embodiments, the system further comprises a second storage container, configured to removably mount with the tank, and to contain a quantity of treated water for subsequent use. In some embodiments, the system further comprises the second storage container is further configured to contain a quantity of disinfectant or disinfectant generation system. In some embodiments, the system further comprises the filter is confined in the tank by cross holes or upsets in the tank to avoid damage to the filter during shock or vibration of the tank. In some embodiments, the system further comprises the filter comprises a filtration element surrounding a core passage, wherein the core passage is in fluid communication with an outlet of the tank. In some embodiments, the system further comprises the filtration element extends along an axis, with a dimension along the axis at least twice its dimension perpendicular to the axis, and where the filter is mounted with the tank such that the axis is horizontal when the tank is in its normal storage orientation.

### BRIEF DESCRIPTION OF DRAWINGS

FIG. 1 is an illustration of an example embodiment of the present invention.

### MODES FOR CARRYING OUT THE INVENTION AND INDUSTRIAL APPLICABILITY

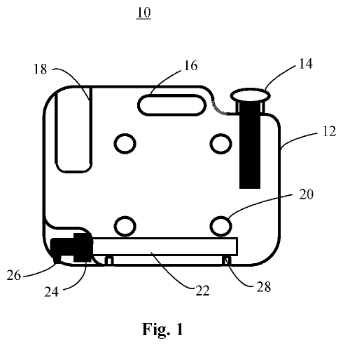

FIG. 1 is an illustration of an example embodiment of water system 10. Air pump 14, for example a manual air pump, mounts with tank 12. Filter 22 is mounted horizontally in the bottom of tank 12 with drain valve 26 located, in the example embodiment, to the left of filter 22. Filter 22 is secured to tank 12 via filter adapter 24. To replace filter 22 after some period of use, filter 22 can be removed from filter adapter 24. Filter 22 can be protected from damage by a plastic cage which mounts with the tank and surrounds filter 22. In the example embodiment, filter 22 is secured in position by confining filter 22 between cross holes 20 and upsets 28 molded into the bottom of tank 12. By confining filter 22 between cross holes 20 and upsets 28, filter 22 cannot move sufficiently to break filter 22 near its attachment to filter adapter 24. Tank 12 can incorporate a carrying handle 16. Cross-holes 20 through tank 12 can provide reinforcement so that the sides of tank 12 do not bulge out excessively when air pressure is applied to tank 12. An electrolytic disinfection device can be included in a container stored with the tank, for example in storage pocket 18. In another example embodiment, storage pocket 18 can contain a water storage bottle that is used to store treated water. When the water storage bottle is not in use, it can store a disinfection component. Storage pocket 18 can be made to fit a specific bottle design, for instance, a 32-ounce Nalgene (trademark of its owner) bottle that is universally available worldwide.

The present invention provides several advantages over prior systems. One advantage of the present design is the mounting of filter 22 in a horizontal orientation. In previous systems, the filter is mounted vertically and hangs from the top of tank 12. During storage over extended periods of time, the filter in current design systems can dry out. Once the filter is dry, it will become unusable and requires replacement. Another advantage of mounting filter 22 in the horizontal position is that all of filter 22 membrane element strands are fully in contact with the filtered fluid for most of the fluid volume of tank 22. With the filter hanging vertically, studies have shown that only the wetted portion of the filter is available for filtration. For a 20-liter tank with the filter hanging vertically, the volume of water passage with 6 liters in the 20 liter tank, it takes greater than 2 minutes to filter 1 liter of water with a starting pressure of 9 pounds per square inch (psi). With the filter mounted vertically and with the tank full of water and 9 psi applied to the tank, the filter takes 40 seconds to process one liter of water. With 6 liters of water in the example embodiment where filter 22 is mounted horizontally, and a starting pressure of 9 psi, it only takes 30 seconds to filter one liter of water.

In contrast to prior designs, when filter 22 is mounted in a horizontal configuration near the bottom of tank 12, filter 22 can stay immersed in even a small amount of water left in tank 12, thereby avoiding drying out as with prior designs. In order to avoid biofilm growth during storage on filter 22 or the inside of tank 12, a disinfection component can be added to the water to maintain a disinfectant residual value to eliminate biofilm growth on filter 22. Many of the filter elements utilized in these types of applications are impervious to damage from exposure to disinfectant chemicals such as chlorine. As a result, filter 22 will still be viable and biofilm free after extended periods of storage and is immediately useful when utilized after an extended storage period. Filter 22 in the present invention can be of various types including particle filters to remove turbidity (but not necessarily pathogens), micro filters that are effective at removing bacteria and protozoa, and ultra filters that are effective at removing all classes of pathogens including virus, bacteria, and protozoa. If a micro filter or particle filter is used, air pump 14 might not be needed if gravity flow of water through such filters is sufficient. The disinfection component can be added to this filtered water to destroy any remaining pathogens that may pass through filter 22. Ultra filters are effective at removing all classes of pathogens, and the disinfection component might not be required if an ultra filter is used.

Another advantage of the example embodiment in FIG. 1 is that system 10 can comprise a disinfection component such as an electrolytic disinfection system that converts common salt (sodium chloride) to a chlorine-based disinfectant. Alternate disinfectants include chlorine tablets, chlorine dioxide treatment, iodine tablets, liquid chlorine solutions, or other types of disinfectants that can provide a second barrier for treatment as well as a lasting disinfectant residual value. Filter 22 in tank 12 removes turbidity and removes pathogens, but it does not provide a residual disinfection value in the treated water. The disinfection system included with the system provides comprehensive treatment and protection in the finished water, in a single robust and inexpensive system, easy to transport and store.

Another advantage of example embodiments of the present invention is the addition of storage of a clean water container in storage pocket 18. The clean water storage container can be used for storage of clean water, and can also be used to store the disinfection component when the system is not in use. In order to attach the clean water container to tank 12 a lanyard can be used to attach the clean water container to tank 12. The lanyard can also incorporate a clip that easily allows separation of the clean water container from tank 12.

One of the advantages of the current invention is that the system can be produced relatively inexpensively, which allows the system to be practical in low income settings and for disaster relief. As an example, hollow fiber filters can be used since they are low cost and readily available in the market. However, hollow fiber filters are easily damaged by physical contact, and can also be damaged over time by backwashing operations. Studies have been conducted by Anna Murray at Tufts University (see Anna Murray, Mario Goeb, Barbara Stewart, Catherine Hopper, Jamin Peck, Carolyn Meub, Ayse Asatekin and Daniele Lantagne, “Fouling in hollow fiber membrane microfilters used for household water treatment”, Journal of Water, Sanitation, and Hygiene for Development, 2014) that show that hollow fiber micro filters can be effective when first used, but will become compromised by backwashing operations that cause the hollow fibers to break. In an example embodiment, a hollow fiber filter bundle is first enclosed in a loose mesh fabric, and is then housed in a durable plastic housing that has larger openings therethrough. This configuration allows for easy physical cleaning of filter 22 by rinsing filter 22 in flowing water, or by immersing filter 22 in clean water and swirling it around, without subjecting filter 22 to direct damage or backwash conditions or by breakage of filter 22 when applying lateral motion to filter adapter 24 during the swirling or cleaning operation.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. A water purification and storage system, comprising (a) a tank configured to accept and hold water, and (b) a filter mounted with the tank in a configuration such that the filter is contacted by water in the tank when the tank is in its normal storage orientation and the water in the tank is 25% or more of the tank's holding capacity.

2. A system as in claim 1, further comprising an air pump mounted with the tank and configured to allow a user to pressurize the contents of the tank such that water is forced under pressure through the filter.

3. A system as in claim 1, further comprising a disinfection system mounted with the tank, configured to supply a chemical disinfectant in quantities suitable for treating a volume of water equal to the tank's holding capacity.

4. A system as in claim 1, further comprising a second storage container, configured to removably mount with the tank, and to contain a quantity of treated water for subsequent use.

5. A system as in claim 4, wherein the second storage container is further configured to contain a quantity of disinfectant or disinfectant generation system.

6. A system as in claim 1, wherein the filter is confined in the tank by cross holes or upsets in the tank to avoid damage to the filter during shock or vibration of the tank.

7. A system as in claim 1, wherein the filter comprises a filtration element surrounding a core passage, wherein the core passage is in fluid communication with an outlet of the tank.

8. A system as in claim 7, wherein the filtration element extends along an axis, with a dimension along the axis at least twice its dimension perpendicular to the axis, and where the filter is mounted with the tank such that the axis is horizontal when the tank is in its normal storage orientation.
